(19) United States
(12) Patent Application Publication
(10) Pub. No.: US 2025/0149899 A1
(43) Pub. Date: May 8, 2025

(54) Classifying Decentralized Energy Resources For Controlling A Power Grid

(71) Applicant: Siemens Aktiengesellschaft, München (DE)

(72) Inventors: Robin Derzbach, Alzenau (DE); Robin Sudhoff, Essen (DE); Sebastian Schreck, Nürnberg (DE); Sebastian Thiem, Neustadt an der Aisch (DE); Mathias Duckheim, Erlangen (DE)

(73) Assignee: Siemens Aktiengesellschaft, München (DE)

(21) Appl. No.: 18/934,524

(22) Filed: Nov. 1, 2024

(30) Foreign Application Priority Data
Nov. 3, 2023 (DE) 10 2023 210 923.9

(51) Int. Cl. H02J 3/38; G05B 13/02; H02S 10/20

(52) U.S. Cl. CPC H02J 3/381; G05B 13/027; H02J 2300/24; H02S 10/20

(57) ABSTRACT

Various embodiments of the teachings herein include a method for classifying decentralized energy resources within a power grid for control of the power grid. An example includes: determining an affiliation of a respective decentralized energy resource to one of a plurality of classes using an artificial neural network; and carrying out the affiliation by determining an affiliation of the respective energy resource to one of the classes. The artificial neural network is trained to use a load series as input data and determine the assignment of the respective load series to one of the plurality of classes as output data. Multiple specified classes are associated with a technical type of the respective decentralized energy resource. Each of the energy resources is provided with a load series associated with the respective energy resource.

### CROSS-REFERENCE TO RELATED APPLICATIONS

This application claims priority to DE Application No. 10 2023 210 923.9 filed Nov. 3, 2023, the contents of which are hereby incorporated by reference in their entirety.

### TECHNICAL FIELD

The present disclosure relates to power grids. Various embodiments of the teachings herein include systems and/or methods for classifying decentralized energy resources in a power grid.

### BACKGROUND

An increasing spread of distributed decentralized energy resources (DERs), for example photovoltaic installations, electric vehicles, heat pumps and battery stores, leads to significant technical challenges for distribution networks, or power grids. This is because distribution networks are typically designed for unidirectional current flow from central generators to decentralized loads, and not for handling the bidirectional current flows caused by DERs. The high pervasion of DERs can lead to voltage disturbances, thermal overload and a risk to network stability.

In order to overcome the technical challenges mentioned, it is necessary to determine the location and availability of flexible assets within the power grid. They can typically provide auxiliary services such as frequency regulation, voltage support or load shifting to support network operation. Typically, however, incomplete information is available, for example about the technical type, the location within the power grid or the power, of installed flexible assets, or DERs.

According to the prior art, the identification, or classification, of flexible assets of this kind (DERs) is carried out manually, that is to say these are based on manual surveys, officially prescribed notifications of asset installations or estimates. The manual methods mentioned are time-consuming, error-prone and costly. This can lead to incorrect planning and implementation of network reinforcements or digitization measures.

### SUMMARY

The teachings of the present disclosure include systems and methods for identifying decentralized energy resources, in particular flexible assets, within a power grid and, based thereon, enabling improved operation of the power grid. For example, some embodiments include a method for classifying decentralized energy resources (42′) within a power grid (1), the classification being provided for control of the power grid (1), the classification having multiple specified classes (42) associated with the technical type of the respective decentralized energy resource (42′), and the classification being carried out by determining an affiliation of the respective energy resource (42′) to one of the classes (42), wherein each of the energy resources (42′) is provided with a load series (41) associated with the respective energy resource (42′), characterized in that the affiliation to one of the classes (42) is determined by means of an artificial neural network, the artificial neural network being designed and trained to use one of the load series (41) as input data, and to use the input data to determine the assignment of the respective load series (41) used as input to one of the classes (42) as output data.

In some embodiments, the classification comprises flexibly controllable assets as a class (42).

In some embodiments, the classification comprises at least the technical types battery stores, heat pumps, charging stations and photovoltaic installations as a respective class (42).

In some embodiments, one or more of the load series (41) are provided by smart meter data of the respective energy resource (42′).

In some embodiments, one or more of the load series (41) are in the form of a residual load series.

In some embodiments, the artificial neural network is trained by means of load series (41) of known types of decentralized energy resources (41′).

In some embodiments, the artificial neural network is trained by using a binary cross-entropy as a loss function.

In some embodiments, the artificial neural network is trained by using a statistical gradient method as an optimizer.

In some embodiments, the artificial neural network has an input layer (100) for the input data, an output layer (103) for the output data and at least two hidden layers (101, 102), in particular exactly 2 hidden layers.

In some embodiments, the artificial neural network has the function ReLU as inner activation function and the function Sigmoid as outer activation function.

As another example, some embodiments include a method for controlling a power grid (1), one or more decentralized energy resources (42′) being connected to the power grid via a respective network node of the power grid (1), characterized in that the technical type of one or more of the energy resources (42′) as described herein is identified, wherein the electrical power to the respective network node is controlled on the basis of the technical type (42) of the respective energy resources (42′) that is connected to the respective network node and identified.

In some embodiments, the decentralized energy resources (42′) are in the form of flexibly controllable assets.

In some embodiments, the decentralized energy resources (42′) are in the form of battery stores, heat pumps, charging stations or photovoltaic installations.

As another example, some embodiments include a computer program product, characterized in that it comprises instructions that, when the program is executed by a computer, cause said computer to carry out one or more of the methods described herein.

### BRIEF DESCRIPTION OF THE DRAWINGS

Further advantages, features, and details of the teachings herein emerge from the exemplary embodiments described below and with reference to the drawings, in which, schematically:

FIG. 1 shows a power grid with multiple decentralized energy resources incorporating teachings of the present disclosure;

FIG. 2 shows a symbolized classification of the decentralized energy resources of the power grid incorporating teachings of the present disclosure; and

FIG. 3 shows a neural network for classifying decentralized energy resources incorporating teachings of the present disclosure.

Identical, equivalent or functionally identical elements may be provided with the same reference signs in one of the figures or throughout the figures.

### DETAILED DESCRIPTION

Some examples of the teachings herein include a method for classifying, or identifying, decentralized energy resources within a power grid, the classification being provided for control of the power grid, the classification having multiple specified classes associated with the technical type of the respective decentralized energy resource, and the classification being carried out by determining an affiliation of the respective energy resource to one of the classes, wherein each of the energy resources is provided with a load series associated with the respective energy resource. The affiliation to one of the classes is determined by means of an artificial neural network, the artificial neural network being designed and trained to use one of the load series as input data, and to use the input data to determine the assignment of the respective load series used as input to one of the classes as output data.

Decentralized energy resources (DERs) are flexible assets. Flexible assets permit, at least in principle, their operation to be shifted in time and/or their power in terms of generation and/or consumption to be adjusted. Furthermore, DERs are renewable decentralized energy resources. Identification of DERs is equivalent to the aforementioned classification of DERS, since the classes are at least associated with the technical type of the respective asset. For example, the classification comprises the class of photovoltaic installations, the class of heat pumps, the class of charging stations for electric vehicles and the class of battery stores. The classification may also comprise the class of non-identified, that is to say non-classifiable, DERs.

The classification of the DERs is intended for control and/or regulation of the power grid. It is thus used for control/regulation of the power grid. The power grid comprises a medium-voltage system and/or low-voltage system.

A load series is a time-dependent power that can relate to generation (infeed into the power grid) and/or consumption (outfeed from the power grid) and that, as a time series, can be present discretely or continuously as a function. Typically, the load series is available as a time series comprising 15 minute steps.

The term “neural network” means an artificial neural network.

The methods incorporating teachings of the present disclosure include identifying one or more DERs within the power grid by way of the aforementioned classification. It is not necessary to identify all DERs in this case. However, there may be provision for this. The classification is carried out in accordance with multiple classes, which are at least associated with the technical type of the asset, that is to say with the technical type of the DERs. Each decentralized energy resource is assigned to one of the classes and thus their technical type, or their technical configuration, is identified.

The classification and thus the identification are carried out by means of an artificial neural network. In this case, the artificial neural network is designed and trained to use each of the load series as input data, and to use the input data to determine the assignment of the respective load series used as input to one of the classes as output data. In other words, a load series from an as yet unclassified DER is fed to the artificial neural network as input. The artificial neural network is designed and trained in such a way that it uses the input, that is to say the load series, to determine the class of the DER and thus identifies it. In other words, the DERs are classified, or the DERs are identified, by means of their respective load series. The invention thus uses known (historical) measurement data, that is to say the load series, to identify the DERs. The load series can preferably be provided by smart meters in this case.

The embodiments of the teachings herein offer one or more of the following:
The use of smart meter data results in an efficient and cost-effective method, as these data are typically already available;
The method is accurate and reliable, since initially only historical time series data have been used to determine the location and availability of flexible assets, that is to say to classify, or identify, them;
The method can cover multiple instances of application;
The method permits a user-friendly and automated application for displaying the identified flexible assets, for example for network operators;
The method permits better planning of network expansion and/or digitization efforts for power grids;
The method can improve the stability and reliability of the distribution network, or the power grid.

Furthermore, the methods can also be used by energy service providers (Energy as a service; EaaS provider). In this case, it is possible to determine whether certain assets, or DERs, have changed in the building/location maintained by the EaaS provider. Such a change/addition of assets, for example a new construction or addition of a photovoltaic installation, may require a new contract and/or further technical measures.

Furthermore, the methods improve planning of network expansion, operation of the power grid and enables improved prediction for renewable energy communities, aggregators, assets and network operators.

The method for controlling a power grid, wherein one or more decentralized energy resources are connected to the power grid via a respective network node of the power grid, is characterized in that the technical type of one or more of the energy resources as described herein is identified, wherein the electrical power to the respective network node is controlled on the basis of the technical type of the respective energy resources that is connected to the respective network node and identified.

In some embodiments, the classification comprises flexibly controllable assets as a class. In other words, flexibly controllable assets, that is to say flexible decentralized energy resources, are identified within the power grid. This is the case because they provide flexibility for controlling the power grid, and so less control power or fewer network expansion measures may be required and network stability is improved. The flexible assets are identified in this case as a result of the classification comprising the class of flexible assets, that is to say a class associated with the technical type of the flexible assets. In addition, the classification may comprise a class for non-flexibly controllable assets, or non-flexibly controllable decentralized energy resources.

In some embodiments, the classification comprises at least the technical types battery stores, heat pumps, charging stations and photovoltaic installations as a respective class. In other words, the classification comprises at least four classes: the battery store class, the heat pump class, the charging station class and the photovoltaic installation class. If a decentralized energy resource is assigned to one of these classes, it is identified as a battery store, as a heat pump, as a charging station or as a photovoltaic installation. There may be provision for further classes regarding further technical types, or configurations, of the decentralized energy resources.

In some embodiments, one or more of the load series are provided by smart meter data of the respective energy resource. This may provide an advantage because smart meter data are typically available and accessible. Furthermore, smart meters have an ID that uniquely identifies the energy system, for example a building comprising the decentralized energy resource, and so the location of the decentralized energy resource within the power grid is thus known. In other words, each asset (decentralized energy resource) is assigned to its respective smart meter and thus to the smart meter ID. The artificial neural network is thus designed and trained to recognize patterns in the smart meter data and thus to identify the assets, the decentralized energy resources.

In this case, the method for classification, or identification, can be carried out by means of a computing device that is connected to the smart meters for the purpose of data interchange. Furthermore, at least part, in particular all, of the method can be carried out by one or more smart meters. In addition, the method can be carried out, or performed, at regular intervals of time.

This enables changes in the infrastructure, that is to say with regard to decentralized energy resources, to be detected and taken into account. If there is not enough smart data available to identify, for example, assets at an end customer system connection, it is also possible to use collection of smart meter data, for substations and/or energy example at the network level of substations communities, and/or calculated virtual smart meter measurements that have been determined, for example, by means of a condition estimation.

In some embodiments, one or more of the load series are in the form of a residual load series. In other words, it is advantageous to use the load series that indicate the remaining energy requirements of the DERs in terms of generation or consumption. For example, in a photovoltaic installation, some is consumed by the associated energy system itself and only a remaining portion of the total generation of the photovoltaic installation is fed into the power grid. The residual load series of this photovoltaic installation indicates the portion that is not consumed by the user and thus the amount that is fed in.

In some embodiments, the artificial neural network is trained by means of load series of known types of decentralized energy resources. In other words, it is necessary for the artificial neural network used for the method to be appropriately designed and appropriately trained. The artificial neural network is trained in this case by means of known load series of known decentralized energy resources. In principle, this can be accomplished using multiple known learning methods for artificial neural networks.

In some embodiments, the artificial neural network is trained by using a binary cross-entropy as a loss function. In other words, the binary cross-entropy is used as a loss function for training. This can reduce the training time. In addition, the artificial neural network trained in this way is faster, meaning that the classification takes place in a shorter computing time. This can advantageously save computing resources.

The training and use of the artificial neural network fundamentally require its activation function, its loss function, the optimizer used and its layers to be specified. Thus, the artificial neural network may be trained by using a statistical gradient method as an optimizer. This permits efficient training of the neural network.

In some embodiments, the artificial neural network has an input layer for the input data, an output layer for the output data and at least two hidden layers, in particular exactly 2 hidden layers. This provides a neural network designed in particular for complex pattern recognition within the training data and the smart meter data.

In some embodiments, the artificial neural network has the function ReLU as inner activation function and the function Sigmoid as outer activation function. ReLU is an advantage in this case, as zero gradients do not occur if the initialization is good enough. Sigmoid may be advantageous because the output values of the individual neurons of the output layer can be interpreted as the probability of an input (load series) being affiliated to a specific class.

ReLU denotes the function f(z)=max (0,z) (rectifier). Sigmoid denotes the function f(z)=1/(1+exp (−z)) (sigmoid function).

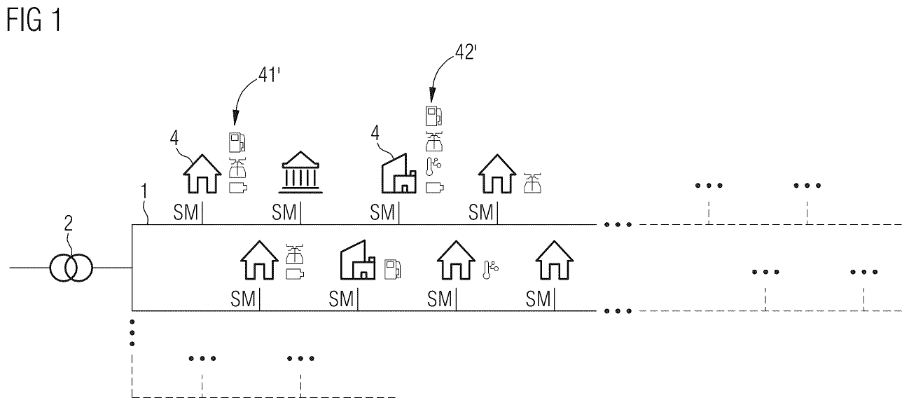

FIG. 1 shows a power grid 1 with multiple decentralized energy resources 41′,42′.

The power grid 1 is in particular in the form of a medium-voltage system and/or low-voltage system. Furthermore, the power grid 1 is connected to a higher-level power grid, in particular to a high-voltage system and/or medium-voltage system, via a transformer 2.

FIG. 1 shows multiple energy systems 4, in particular buildings, each comprising one or more decentralized energy resources 41′,42′ (DERs). The decentralized energy resources 41′,42′ are in the form of energy-related assets of a specific technical type, for example as a photovoltaic installation, as a battery store, as a heat pump or as a charging station for electric vehicles.

Furthermore, each of the energy systems 4 in the present case has a smart meter, which is identified in FIG. 1 by the symbol SM. In this case, the smart meters record at least one respective residual load as a load series. In other words, the power grid 1 (distribution network) has multiple energy systems 4, which comprise in particular various technical types of flexible assets 41′,42′, for example battery stores, heat pumps, charging stations for electric vehicles, photovoltaic installations, electric heaters and/or air conditioning installations.

In this case, one or more of the aforementioned DERs 41′,42′, or the aforementioned flexible assets 41′,42′, may be known to a network operator of the power grid 1. These known DERs are identified by the reference sign 41′. In other words, these known DERs are already classified, or identified, for example by data provided by the energy system 4.

However, not all of the DERs 41′,42′ are typically classified, or identified, in terms of their technical type. The assets to be classified in this way are identified by the reference sign 42′. Thus, a power grid 1 typically comprises already classified DERs 41′ and DERs 42′ that are to be classified.

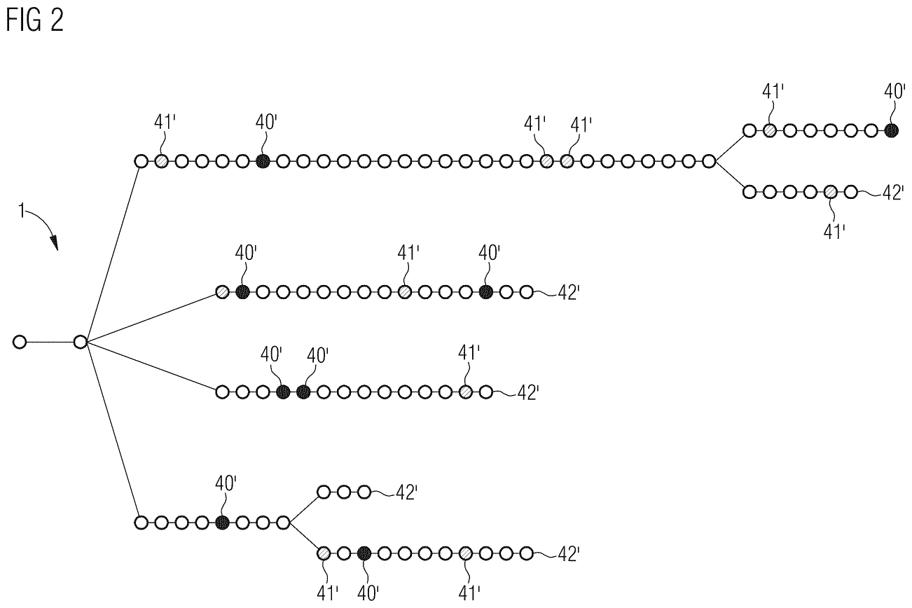

FIG. 2 shows a symbolized classification of the decentralized energy resources 41′,42′ of the power grid 1 with regard to a class, for example the class of energy systems comprising a battery store. In this case, the power grid 1 has been further abstracted and the classification/identification of the individual DERs 41′,42′ with regard to the one class has been symbolized by respective hatching.

In a manner comparable to FIG. 1, the power grid 1 in this case comprises already classified assets 41′, assets 42′ that are to be classified and assets 40′ that are not affiliated to the class under consideration. However, the assets 40′ that are not affiliated to the class under consideration may be affiliated to another class. A DER cannot be affiliated to the class in this case if its probability of being affiliated to the class associated with the technical type of assets, which is calculated by means of an artificial neural network, is less than a specified threshold value.

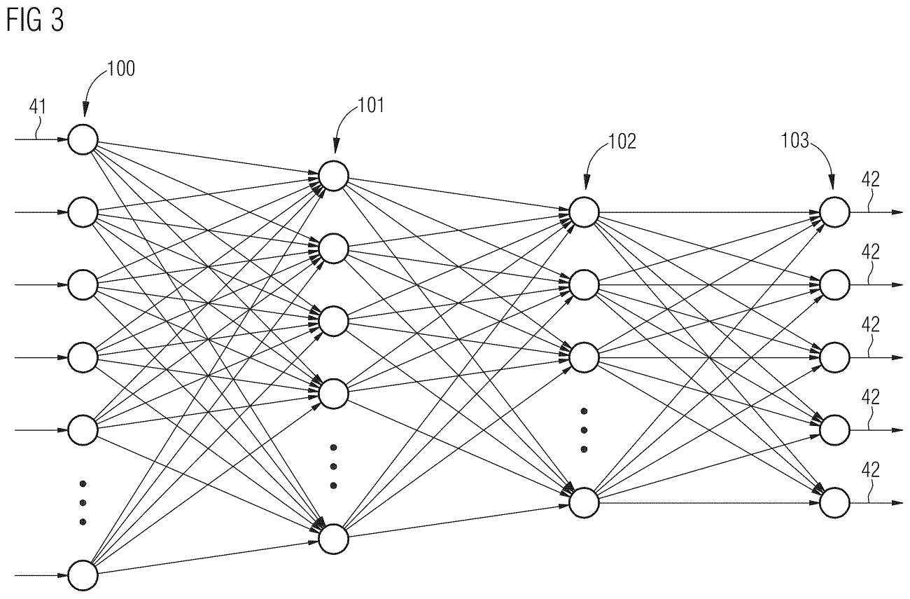

FIG. 3 shows an artificial neural network that is designed and trained to classify DERs. The neural network has an input layer 100, an output layer 103 and two hidden layers 101, 102. The input layer 100 is designed to receive load series 41, in particular residual load series, as input data.

The output layer 103 indicates the affiliation of a load series 41 used as input, or input data, to a class 42 of the classification. In this case, multiple instances of the classes 42 are associated with fundamentally possible technical types of the DERs. The output data additionally preferably indicate the probability of a load series 41 being affiliated to its assigned classes 42. In other words, the DERs are thus identified in terms of their technical type, or in terms of their technical configuration.

Thus, an artificial neural network is used that is trained to recognize patterns and properties of the DERs, in particular of flexible assets, within load series, in particular within smart meter data. The artificial neural network is trained by means of a dataset of already indicated data, which comprises information about the installation of the DERs to be identified, such as batteries, heat pumps, chargers for electric vehicles and/or PV systems with the corresponding smart meter data. The artificial neural network trained in this way can identify DERs, in particular flexible assets, within new datasets/load series, for example smart meter data, with a high degree of accuracy. It is advantageous in this case if the load series/data used for classification are comparable to the data used during training. Furthermore, a correspondingly large volume of data is advantageous for training. Semi-supervised learning (SSL) can preferably be used as a training method.

Although the teachings of the present disclosure have been described and illustrated in more detail by way of the exemplary embodiments, the scope thereof is not restricted by the disclosed examples, or other variations may be derived therefrom by a person skilled in the art without departing from the scope of protection of the present disclosure.

### LIST OF REFERENCE SIGNS

1 power grid
2 transformer
4 energy system
40′ energy resource not affiliated to the class
41′ classified energy resource
42′ energy resource to be classified
41 load series
42 class
100 input layer
101 hidden layer
102 hidden layer
103 output layer

1. A method for classifying decentralized energy resources within a power grid for control of the power grid, the method comprising:
determining an affiliation of a respective decentralized energy resource to one of a plurality of classes using an artificial neural network;
wherein the artificial neural network is trained to use a load series as input data and determine the assignment of the respective load series to one of the plurality of classes as output data;
wherein multiple specified classes are associated with a technical type of the respective decentralized energy resource;
carrying out the affiliation by determining an affiliation of the respective energy resource to one of the classes;
wherein each of the energy resources is provided with a load series associated with the respective energy resource.

2. The method as claimed in claim 1, wherein the class defines a set of flexibly controllable assets.

3. The method as claimed in claim 1, wherein the class defines technical types including: battery stores, heat pumps, charging stations, and photovoltaic installations.

4. The method as claimed in claim 1, wherein one or more of the load series are provided by smart meter data of the respective energy resource.

5. The method as claimed in claim 1, wherein one or more of the load series include a residual load series.

6. The method as claimed in claim 1, wherein the artificial neural network is trained by load series of known types of decentralized energy resources.

7. The method as claimed in claim 6, wherein the artificial neural network is trained by using a binary cross-entropy as a loss function.

8. The method as claimed in claim 6, wherein the artificial neural network is trained by using a statistical gradient method as an optimizer.

9. The method as claimed in claim 1, wherein the artificial neural network includes: an input layer for the input data, an output layer for the output data, and at least two hidden layers.

10. The method as claimed in claim 1, wherein the artificial neural network has the function ReLU as inner activation function and the function Sigmoid as outer activation function.

11. A method for controlling a power grid including one or more decentralized energy resources connected via a network node of the power grid, the method comprising:
identifying a technical type of one or more of the energy resources; and
controlling electrical power to the respective network node based at least in part on the technical type of the respective energy resources connected to the respective network node.

12. The method as claimed in claim 11, wherein the decentralized energy resources comprise flexibly controllable assets.

13. The method as claimed in claim 11, wherein the decentralized energy resources include: battery stores, heat pumps, charging stations, and/or photovoltaic installations.
